(19) United States
(12) Patent Application Publication
(10) Pub. No.: US 2012/0027198 A1
(43) Pub. Date: Feb. 2, 2012

(54) System and method for cryptographic communications using permutation

(75) Inventor: Zhijiang He, Sunnyvale, CA (US)

(73) Assignee: Dr. ZHIJIANG HE, SUNNYVALE, CA (US)

(21) Appl. No.: 12/321,936

(22) Filed: Jan. 27, 2009

Related U.S. Application Data
(60) Provisional application No. 61/065,591, filed on Feb. 13, 2008.

(51) Int. Cl. H04L 9/28

(52) U.S. Cl. 380/28

(57) ABSTRACT

The present invention discloses a system and method for cryptographic communications. It may significantly improve operation efficiency of existing symbol level encryption algorithms by permutating at symbol sequence level with significantly less computational requirements. The system includes a communications channel, at least one terminal with encoding device and at least one terminal with decoding device. A message comprising ordered symbols can be partitioned into ordered symbol sequences. Then the order of symbol sequences is permutated by the encoding device. The partition and permutation can be repeated recursively on the resultant symbol sequences to obtain the ciphertext. All the partition and permutating information are characterized by a secret key, used for decoding on the receiving terminal. It is required that the final resultant symbol sequences in the ciphertext should not disclose information confidentiality. The present invention can be also applied to secure distributed data storage.

### CROSS-REFERENCE TO RELATED APPLICATIONS

This application claims the benefit of provisional patent application No. 61/065,591 filed on date Feb. 13, 2008, “A System and Method For Cryptographic Communications Using Permutation”.

### FEDERALLY SPONSORED RESEARCH

Not Applicable

### SEQUENCE LISTING OR PROGRAM

Not Applicable

### US PATENT REFERENCES

1. U.S. Pat. No. 4,405,829 September 1983, Rivest, Ronald L. et al, Cryptographic communications system and method

### BACKGROUND OF THE INVENTION

1. Field of the Invention

The present invention relates to a cryptographic communications system and method.

2. Description of the Related Art

Data privacy and security have been increasingly important in generation, exchange and storage of information. Data transmitted over communications channels are susceptible to interception, eavesdropping and modification. Computer networks and internet can be monitored, accessed without permission. Due to various reasons, data storage devices may be accessed undesirably. Therefore, a cryptographic communications system and method is undoubtedly required to protect information confidentiality.

There have been a plurality of encryption algorithms to protect information security. These encryption algorithms involve extensive arithmetic operations and bit/symbol substitution, therefore, require substantial computing power. Some sophisticated approaches even require dedicated hardware acceleration to achieve targeted performance. Fundamentally, the daunting computing cost is due to the fact that all current transformations and mathematical operations are performed at symbol/bit level to prevent bit/symbol level security breaches.

However, in a plurality of secure communications applications, symbol/bit level data security may not be required. For instance, in on-line software release, a binary executable is a bit sequence of 1s and 0s. Current encryption algorithms would encode the binary executable at bit level, which would be time consuming.

Nonetheless, encoding binary executables at bit sequence level can achieve data security at lower computational cost. For example, a 64-kilo-byte binary executable can be first partitioned into 64 1-kilo-byte bit sequences. Then these 64 1-kilo-byte bit sequences can be permutated to generate an encoded form of the binary executable ready for on-line software release.

In this example of encoding 64-kilo-byte binary executable at 1-kilo-byte bit sequence level, the permutation information can be defined as a secret key for this encryption. There are factorial 64! possible permutations, more complex than exponential complexity. Thus, without knowing the secret key, it is computationally infeasible to restore the order of the re-ordered 64 1-kilo-byte bit sequences and obtain the original binary executable using current computing technologies.

Furthermore, symbol sequence level permutation operates at symbol sequence level, therefore, may significantly improve encryption and decryption efficiency compared to symbol/bit level cryptographic manipulations.

Since symbol sequence level permutation encodes and decodes messages using the same secret key, it is a symmetric encryption approach.

Accordingly, it is an object of this invention to provide a system and method for implementing a secure communications system.

It is another object to provide a system and method for encoding and decoding data.

It is yet another object to provide a system and method for secure distributed data storage.

### BRIEF SUMMARY OF THE INVENTION

The present invention includes a communications channel, at least one terminal with an encoding device and at least one terminal with a decoding device. The encoding device transforms an applied message-to-be-transmitted M to a ciphertext C for transmission over the communications channel to the receiving terminal.

To clearly describe the symbol sequence level partition and permutation method, the symbol level permutation method is presented first. It is a special case of symbol sequence level permutation, where each of the symbol sequences comprises only one symbol.

Please note that the present invention included in this patent application specification is about symbol sequence level partition and permutation. The description of symbol level permutation only serves to delineate key concepts of symbol sequence level encryption.

The message M is an ordered symbol sequence of length k and can be represented as a k-tuple (mₖ, . . . , m₂, m₁), k<=kₘₐₓ, where kₘₐₓ is the maximum symbol length of messages specified by the communications system. Please note that elements within parenthesis are counted from right to left in this patent application specification for consistency.

The symbols in message M can be defined as the minimum units for encryption. For instance, in on-line software release, the bits in binary executables are the minimum units for manipulation. Therefore, symbols refer to bits in this example. In ASCII message communications the minimum manipulation units are ASCII characters. Thus, symbols refer to ASCII characters.

The position of each symbol in M can be defined as another k-tuple (k, k−1, . . . , 2, 1). This information is trivial because it is the obvious original position of each symbol in M. However, this position information will be changed in permutation and can be defined as a secret key for encryption:

For example, an ASCII message ABCDEFGHI can be represented as a 9-tuple (A, B, C, D, E, F, G, H, I). The length of this symbol sequence is 9.

The position of each symbol in M can be represented as a 9-tuple (9, 8, 7, 6, 5, 4, 3, 2, 1), which is obviously trivial.

If the length of M is bigger than kₘₐₓ, then M can be transformed into blocks of length no bigger than kₘₐₓ, which are separately encoded and transmitted over the channel. The encoded blocks are separately decoded on the receiving terminal and transformed back to M. If the length of M is shorter than a minimum length, symbol permutation of M may still leak confidential information of message M. In this case, M can be padded to a longer sequence. Therefore, symbol permutation will not leak confidential information. The padded symbols will be dropped after decryption. These two cases apply to symbol sequence level permutation as well.

To obtain ciphertext C, the encoder permutates all symbols in M according to predefined ordering information (pₖ, . . . , p₂, p₁), which is a permutation of (k, k−1, . . . , 1). pᵢ is the position of symbol mᵢ in ciphertext C, where 1<=i<=k. The k-tuple (pₖ, . . . , p₂, p₁) is defined as the secret encryption key. There are a plurality of approaches to reduce the size of the secret key shared by both the encoding device and the decoding device.

For example, the ASCII message ABCDEFGHI can be permutated to a ciphertext EHGBICDFA according to permutation ordering information (p₉, . . . , p₂, p₁)=(1, 6, 4, 3, 9, 2, 7, 8, 5), which is a permutation of (9, 8, 7, 6, 5, 4, 3, 2, 1). The 4 in the 9-tuple (p₀, . . . , p₂, p₁)=(1, 6, 4, 3, 9, 2, 7, 8, 5) means that the 7^{th} symbol C in the message ABCDEFGHI is placed at the 4^{th} position in the ciphertext EHGBICDFA. Apparently, the secret key for this encoding is information (p₉, . . . , p₂, p₁)=(1, 6, 4, 3, 9, 2, 7, 8, 5).

Another form of symbol level permutation encryption is involved with the secret key. In this form, the secret key is always a permutation of (kₘₐₓ, . . . , 2, 1) instead of a permutation of (k, k−1, . . . , 1). Accordingly, messages with length less than kₘₐₓ have to be padded to have length of kₘₐₓ.

For example, assuming kₘₐₓ is 15, the ASCII message ABCDEFGHI is first padded to ABCDEFGHI+JKLMN. Then the padded message is permutated to J EHKGLBIMC+DNFA according to (p₁₅, . . . , p₂, p₁)=(1, 9, 6, 4, 14, 2, 11, 13, 8, 5, 15, 12, 10, 7, 3). Actually, because the positioning information for the remaining 6 padded symbols in the ciphertext is not important, only the first 9 elements in this 15-tuple are needed for decryption. Therefore, the encryption key can be reduced to 9-tuple (p₁₅, . . . , p₈, p₇)=(1, 9, 6, 4, 14, 2, 11, 13, 8).

Unlike symbol level permutation, symbol sequence level permutation is performed at symbol sequence level. The encoding device first partitions M into n symbol sequences as (Mₙ, . . . , M₂, M₁). Each of Mₙ, . . . , M₂ and M₁ is a symbol sequence within M and can be represented as:
(mⱼ₊ₛᵢ₋₁, . . . , mⱼ₊₁, mⱼ)
   where mⱼ is the starting symbol for Mᵢ, 1<=i<=n. sᵢ is the length of Mᵢ, Thus, the partition can be characterized by (sₙ, . . . , s₂, s₁).

For example, the ASCII message ABCDEFGHI can be partitioned into 3 symbol sequences AB CDE FGHI according to partition information 3-tuple (s₃, s₂, s₁)=(2, 3, 4). The 3 in this 3-tuple means that the 2nd symbol sequence of this partition has 3 symbols, i.e. CDE.

Then (Mₙ, . . . , M₂, M₁) is permutated to (M₁ₙ, . . . , M₁₂, M₁₁) according to (pₙ, . . . , p₂, p₁), which is a permutation of (n, n−1, . . . , 2, 1). pᵢ is the sequence position of Mᵢ within the ciphertext (M₁ₙ, . . . , M₁₂, M₁₁), 1<=i<=n. The 1 in the subscript of M₁ᵢ denotes the first level permutation in case of recursive partition and permutation, which will be described in the following. The partition information (sₙ, . . . , s₂, s₁) and permutation information (pₙ, . . . , p₂, p₁) are defined as the secret encryption key.

In the previous ASCII message ABCDEFGHI, the message has been partitioned into (M3, M2, M1)=AB CDE FGHI according to partition information 3-tuple (s₃, s₂, s₁)=(2, 3, 4). Then it is permutated to (M₁₃, M₁₂, M₁₁)=CDE FGHI AB according to permutation information (p₃, p₂, p₁)=(1, 3, 2). The 3 in (p₃, p₂, p₁)=(1, 3, 2) means that the second symbol sequence CDE is placed as the third symbol sequence in the permutation. Please keep in mind that elements in parenthesis are counted from right to left in this application specification.

However, if necessary, the partition and permutation can be repeated recursively and sequentially on the resultant symbol sequences in a manner not necessarily same as previous partition and permutation until stopped by the encoding device. For instance, M₁ᵢ is one of M₁ₙ, . . . , M₁₂ and M₁₁, wherein 1<=i<=n, and can be further partitioned into n′ symbol sequences as (M₁ᵢₙ′, . . . , M₁ᵢ₂, M₁ᵢ₁) according to (s₁ᵢₙ′, . . . , s₁ᵢ₂, s₁ᵢ₁). s₁ᵢⱼ is the number of symbols in M₁ᵢⱼ, 1<=j<=n′. The 1i in the subscript means a partition on sequence M₁ᵢ. Then (M_{1in′}, . . . , M₁ᵢ₂, M₁ᵢ₁) is permutated according to (p₁ᵢₙ′, . . . , p₁ᵢ₂, p₁ᵢ₁), which is a permutation of (n′, n′−1, . . . , 2, 1). (p₁ᵢₙ′, . . . , p₁ᵢ₂, p₁ᵢ₁) and (s_{1in′}, . . . , s₁ᵢ₂, s₁ᵢ₁) may not be necessarily distinct from previous partitions and permutations respectively. The procedure of partition and permutation can be repeated recursively and sequentially on the resultant symbol sequences until stopped by the system.

For the recursive symbol sequence level permutation, the encryption key corresponds to information for all levels of partitions and permutations.

In the ASCII message ABCDEFGHI example, the message is already partitioned and permutated into symbol sequences (M₁₃, M₁₂, M₁₁)=CDE FGHI AB. M₁₂=FGHI can be further partitioned into (M₁₂₂, M₁₂₁)=F GHI according to (s₁₂₂, s₁₂₁)=(1, 3). The 3 in (1, 3) means that the first symbol sequence has 3 symbols, i, e, GHI. (M₁₂₂, M₁₂₁)=F GHI can then be permutated to GHI F according to permutation information (p₁₂₂, p₁₂₁)=(1, 2). The 2 in (p₁₂₂, p₁₂₁)=(1, 2) means that the first symbol sequence M₁₂₁ is placed as the second sequence in GHI F. As a result, the ciphertext is CDE GHI F AB.

In this recursive symbol sequence level permutation of ABCDEFGHI, the encryption key corresponds to (s₃, s₂, s₁)=(2, 3, 4) and (p₃, p₂, p₁)=(1, 3, 2) for partition and permutation on M, (s₁₂₂, s₁₂₁)=(1, 3) and (p₁₂₂, p₁₂₁)=(1, 2) for partition and permutation on M₁₂.

Assuming M is partitioned into n symbol sequences, the number of possible combinations is factorial n!, which is larger than any exponential function in n. If the resultant symbol sequences are further partitioned and permutated, the complexity of encryption is further confounded. Therefore, assuming the resultant symbol sequences do not leak message confidential information, without the knowledge of the secret key, it is computationally infeasible to decode the ciphertext with current computing technology. As a result, symbol sequence level recursive partition and permutation provides sufficient information security for applications with no symbol level security requirement.

The partition and permutation information is used as encryption and decryption key. In some applications, a shared secret encryption key is established between the transmitter and the receiver per session basis. In this case, a distinct key is required for a separate communications session. This distinct encryption key can be encoded by other encryption techniques such as public key encryption techniques, thereafter being transmitted over the communications channel to the intended receiver. For this reason, it is important to shorten or reduce the size of the secret key.

There are a plurality of methods to shorten or reduce the size of the shared secret encryption key. For instance, same partition and permutation schemes can be applied, thus no need to transmit multiple partition and permutation information as the secret encryption key.

Alternatively, some conventional data compression techniques or hashing techniques can be applied on the secret encryption key to reduce the size of the key. When received by the intended receiver, the size-shortened key is converted back to the original secret key, which is applied on the decoding device.

### BRIEF DESCRIPTION OF THE DRAWINGS

FIG. 1 shows a block diagram for a 2-way cryptographic communications system in accordance with the present invention.

FIG. 2 shows a detailed block diagram for an encoding/decoding device in the system in FIG. 1.

FIG. 3 shows another embodiment of detailed block diagram for an encoding/decoding device in the system in FIG. 1.

FIG. 4 shows a block diagram of another embodiment for a cryptographic communications system in accordance with the present invention.

FIG. 5 shows a block diagram of yet another embodiment for a cryptographic communications system in accordance with the present invention.

FIG. 6 shows in block diagram how to encode data and distribute the encoded data to storage terminals in a secure distributed storage system in accordance with the present invention.

FIG. 7 shows in block diagram how to collect distributed encoded data and restore the original data in a secure distributed storage system in accordance with the present invention.

### DETAILED DESCRIPTION OF THE INVENTION

Basic Configuration

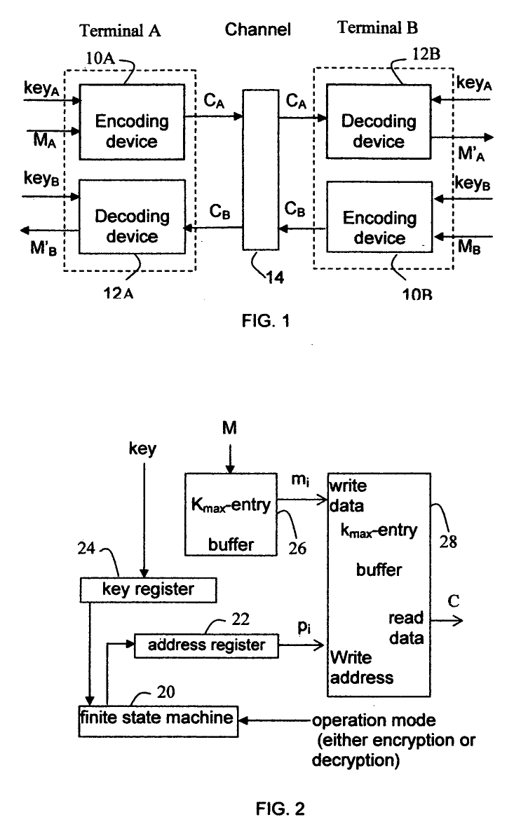

FIG. 1 shows an embodiment of the present invention in block diagram form. This system comprises a communications channel 14 and two terminals A and B. The communications channel 14 in the embodiment in FIG. 1 is a two-way communications channel. Nonetheless, the communications channel consistent with the present invention may be one-way, 2-way or even multi-way in other embodiments. Each of terminals A and B includes encoding device 10A and 10B, respectively, and decoding device 12A and 12B, respectively. An encryption key key_{A} is applied on both encoding device 10A, which transforms a message M_{A} to a ciphertext C_{A}, and decoding device 12B, which transforms the received ciphertext C_{A} back to M′_{A}. Similarly, an encryption key key_{B} is applied on both encoding device 10B, which transforms a message M_{B} to a ciphertext C_{B}, and decoding device 12A, which transforms the received ciphertext C_{B} back to M′_{B}. In other embodiments of one-way communications from terminal A to terminal B, only encoding device 10A and decoding device 12B are required.

A plaintext message M_{A}, represented as (mₖ, . . . , m₂, m₁), can be partitioned into (M_{An}, . . . , M_{A2}, M_{A1}), k<=kₘₐₓ, where kₘₐₓ is the maximum message length allowed by terminal A. If the length of M is bigger than kₘₐₓ, then M is transformed into blocks of length no bigger than kₘₐₓ. The blocks are encoded and transmitted separately. On the receiving terminal, the blocks are decoded separately and transformed back to original message M. If the message length is shorter than the minimum symbol length, then M is padded before encryption to avoid potential information disclosure.

Symbol sequence M_{Ai}, one of M_{An}, . . . , M_{A2} and M_{A1}, is a symbol sequence within M_{A} and its length is s_{Ai}, where 1<=i<=n. When the length of each M_{Ai} is one, this symbol sequence level permutation scheme is reduced to a symbol level permutation, therefore, symbol level permutation is a special case of symbol sequence level permutation.

In the operation of encryption, (M_{An}, . . . , M_{A2}, M_{A1}) is permutated to (M_{A1n}, . . . , M_{A12}, M_{A11}) according to (p_{An}, . . . , p_{A2}, p_{A1}), which is a permutation of (n, n−1, . . . , 2, 1). p_{Ai} is where M_{Ai} is placed within (M_{A1n}, . . . , M_{A12}, M_{A11}). This partition and permutation can be characterized by (s_{An}, . . . , s_{A2}, s_{A1}) and (p_{An}, . . . , p_{A2}, p_{A1}) respectively. Each M_{A1i} can be further partitioned and permutated not necessarily in the same way as previously, wherein 1<=i<=n. This process can be repeated recursively and sequentially until stopped by the encoder. The final sequence of symbol sequences is defined as a ciphertext C_{A}. The information including all levels of partition and permutation schemes characterized by (s_{An}, . . . , s_{A2}, s_{A1}) and (p_{An}, . . . , p_{A2}, p_{A1}) respectively is defined as the secret encryption key, key_{A}. When necessary to reduce the size of the encryption key, same partition and permutation schemes can be applied. Moreover, conventional data compression and hashing techniques can be applied on the encryption key as well.

Please note that, to avoid information disclosure, it is required that the final resultant symbol sequences should not leak any confidential information. Otherwise, the process of recursive partition and permutation should be continued on those leaky symbol sequences until the information security is guaranteed.

In accordance with the present invention, an exemplary form for encoding device 10A, 10B and decoding device 12A, 12B is shown in FIG. 2. The device in FIG. 2 includes an M memory buffer 26 for receiving an applied digital message-to-be-transferred, a key register 24 for receiving an applied digital encryption key and a memory buffer 28 for storing the encoded ciphertext C. The memory buffer 26 has Kₘₐₓ entries and each entry stores one symbol of the message-to-be-transferred in either the top-down order or the bottom-up order as specified by the system. The memory buffer 28 also has Kₘₐₓ entries with each entry storing one symbol of the encoded ciphertext C in an order as specified by the system.

The device further includes a finite state machine 20 and an address register 22. The finite state machine 20 obtains the encryption key from key register 24 and generates a symbol address pᵢ, which is written into the address register 22. A message symbol mᵢ, which is an output from message buffer 26 in an order specified by the system, is written into ciphertext memory buffer 28 at the address specified by pᵢ. This is how the operation of permutation is implemented. It is required that the output of symbol address pᵢ from address register 22 and the output of symbol mᵢ from the message buffer 26 should be synchronized.

The device in FIG. 2 can operate in either encryption or decryption mode using the same encryption key. This is controlled by the finite state machine 20 when generating symbol address pᵢ. If the encryption key is reduced by conventional compression or hashing techniques, the original encryption key can be recovered either before storing into the key register 24, which is not depicted in FIG. 2, or inside the finite state machine 20.

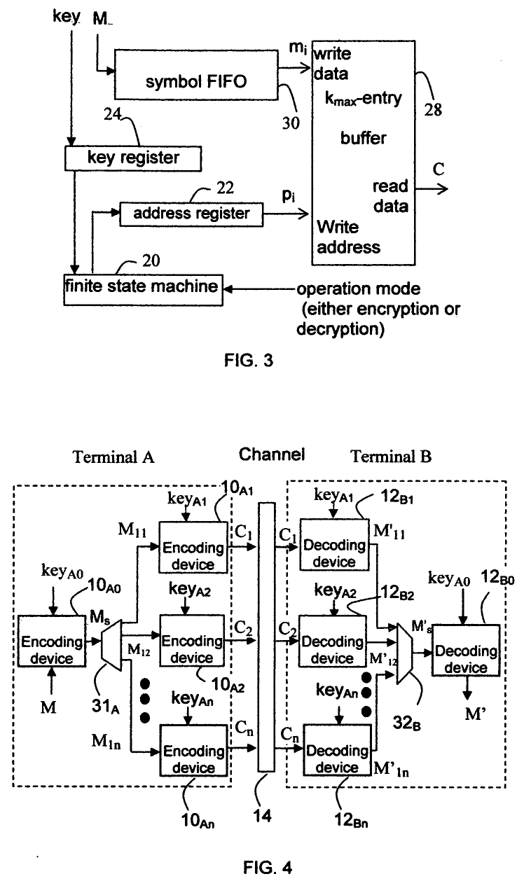

Another embodiment of the encoding and decoding devices consistent with the present invention is shown in FIG. 3. The M memory buffer 26 is replaced by a message symbol FIFO 30. This is the only difference between the embodiment in FIG. 2 and the embodiment in FIG. 3. After all symbols of the message are written into memory buffer 28 in FIG. 2 and FIG. 3, the data in memory buffer 28 are read out in either the top-down order or the bottom-up order as specified by the communications system. This is the ciphertext C.

The embodiments in FIG. 2 and FIG. 3 can only perform permutation one symbol at a time, however, it is possible that the encoding and decoding devices may process more than one symbol at a time in other embodiments of the present invention.

Other Configurations

In the recursive symbol sequence level permutation encryption, every symbol sequence after previous partition and permutation can be partitioned and permutated distinctly and independently. Therefore, it is possible to process each of the symbol sequences in parallel. As embodied in FIG. 4, a message M is partitioned and permutated according to key_{A0} by encoder 10_{A0}, the resultant symbol sequence Mₛ, which is one of M₁ₙ, . . . , M₁₂ and M₁₁, is de-selected by a 1-to-n de-selector (demux) 31_{A} to generate M_{A1i}, where i is in the range of 1 to n inclusive. M_{A1i} is applied on encoding device 10_{Ai} to generate Cᵢ using key_{Ai}. Cᵢ is transmitted to terminal B over the channel 14. Upon received by terminal B. Cᵢ is decoded by decoding device 12_{Bi} to obtain M′₁ᵢ using key_{Ai}, where 1<=i<=n. Then M′ₛ is selected from M′₁ₙ, . . . , M′₁₂ and M′₁₁ by a n-to-1 selector(mux) 32_{B} and is applied to decoding device 12_{B0}. Thereby, message M′ is obtained, which should be the same as M.

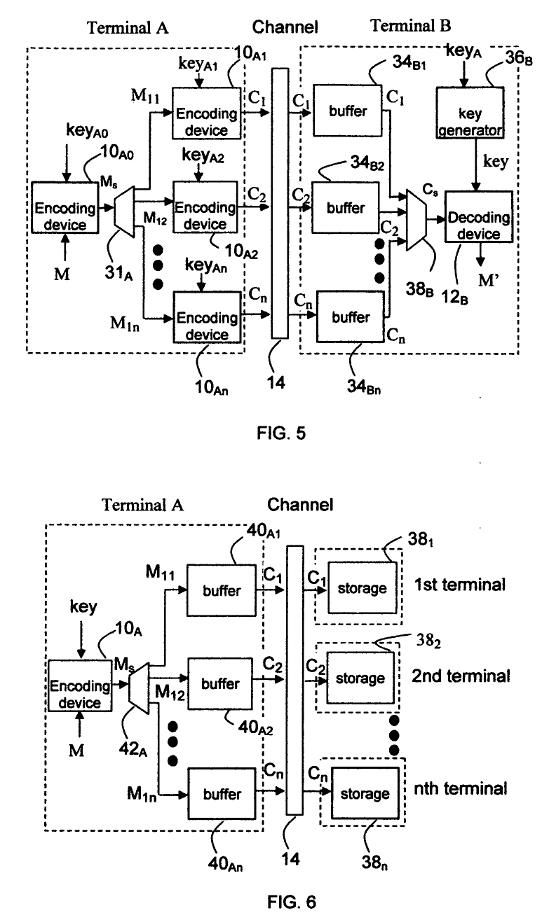

As the decoding of Cᵢ is essentially the same as encoding of M₁, where 1<=i<=n, it is possible to use a single decoder 12_{B}, as embodied in FIG. 5. The terminal A in FIG. 5 is the same as that in FIG. 4. The decoding schemes are different from that in FIG. 4. Ciphertext Cᵢ is received and stored in memory buffer 34_{Bi} Then Cₛ is selected from Cₙ, . . . , C₂ and C₁ by a n-to-1 selector (mux) 38_{B} and decoded by the decoding device 12_{B}. Thereby, M′ is obtained, which is the same as M. The key used by decoder 12_{B} is generated by a key generator 36_{B} according to the particular symbol sequence fed to decoder 12_{B}.

In addition, the finite state machine 20, as embodied in FIG. 2 and FIG. 3, should be designed accordingly to generate correct symbol addresses.

The communications channel in both FIG. 4 and FIG. 5 is shown to have n physical links. However, there may be either multiple physical links or only one physical link to channel 14. How Cₙ, . . . , C₂ and C₁ are transmitted to the receiving terminal should be designed according to the specific communications channel.

There are other forms of encoder/decoder configurations consistent with the present invention in addition to the embodiments in FIG. 4 and FIG. 5. The finite state machine and memory buffers inside the encoding and decoding devices, as embodied in FIG. 2 and FIG. 3, should be designed accordingly. Moreover, the embodiments in FIG. 4 and FIG. 5 are one-way communciations system. Nonetheless, there can be other forms of the present invention capable of two-way or multi-way communications.

Secure Distributed Storage

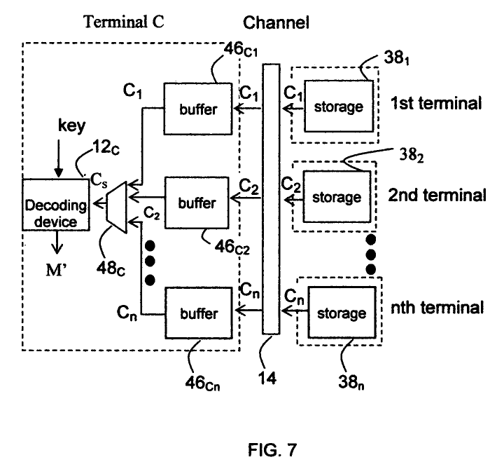

The present invention can also be applied to secure distributed data storage as embodiments in FIG. 6 and FIG. 7. FIG. 6 is an embodiment of the present invention for distributed data storage. It comprises an encoding and distributing terminal A, n distributed data storage terminals and a communications channel 14. Terminal A comprises an encoding device 10A, a 1-to-n deselector (demux) 42_{A}, and n memory buffers from 40_{A1} to 40_{An}. The encoder 10A partitions the message-to-be-stored into n symbol sequences (Mₙ, . . . , M₂, M₁) and permutates them into (M₁ₙ, . . . , M₁₂, M₁₁), which may be further partitioned and permutated. M₁ᵢs are stored into memory buffers 40_{Ai} respectively and transmitted to n distributed storage terminals separately over channel 14, wherein 1<=i<=n. The ith distributed data storage terminal includes a storage device 38ᵢ, where the data is stored.

The embodiment in FIG. 7 describes how the distributed data is recovered. The n data storage terminals are the same as that in FIG. 6. Terminal C, knowing the encryption key, receives Cᵢs from the n storage terminals over channel 14 and store Cᵢs in memory buffers from 46_{C1} to 46_{Cn} respectively. The memory buffers feed Cᵢs to decoding device 12C via an n-to-1 selector (mux) 48_{C}. Cᵢs are decoded by decoding device 12C to obtain message M′, which is the same as original message M.

Conclusion

The present invention describes a recursive symbol sequence level partition and permutation method for cryptographic communications. It is required that the final symbol sequences in the ciphertext should not disclose any information confidentiality. Otherwise, the recursive partition and permutation process should be continued until information security is satisfied. The symbol level permutation method is a special case for symbol sequence level permutation. The present invention can also be applied to secure distributed data storage.

The following variations on the use of the encoding/decoding devices are to be considered as obvious to one skilled in the art and therefore within the intended scope of the attached claims:
1. Using encoders/decoders consistent with the present invention for messages that are either partitioned into smaller blocks to meet maximum message length requirement or padded into longer sequence to meet minimum message length requirement. It is also possible to steal symbols from other symbol sequence when particular symbol sequence is too short
2. Using encoders/decoders consistent with the present invention in conjunction with other types of encoders/decoders. Other encoders/decoders can be used either before or after encoders/decoders consistent with the present invention. Particularly, the symbols may be substituted, if needed, in encoding or decoding consistent with the present invention. The substitution symbols should also be considered as part of the secret encryption key in addition to the partition and permutation information.
3. Using a shared secret key established with other encryption schemes in implementations consistent with the present invention,
4. Using a secret key, size of which is shortened with conventional compression and hashing techniques, in encoding or decoding consistent with the present invention,
5. Implementing the present invention in software alone or hardware alone or as a combination of software and hardware,
6. Implementing the present invention as a standalone system, or embeded into or attached to another system.

The present invention has been disclosed and described with respect to the herein disclosed embodiments. However, these embodiments should be considered in all respects as illustrative and not restrictive. Other forms of the present invention could be made within the spirit and scope of the invention.

What is claimed is:

1. A cryptographic communications system, comprising:
A. a communications channel,
B. an encoding means for transforming a message signal M to a ciphertext signal C for transmitting on said channel,
where said message M is an ordered sequence of symbols, denoted as (mₖ, . . . , m₂, m₁), k<=kₘₐₓ, where kₘₐₓ is the maximum message symbol length specified by said system, wherein
said transforming partitions said message M into (Mₙ, . . . , M₂, M₁) and permutates (Mₙ, . . . , M₂, M₁) to (M₁ₙ, . . . , M₁₂, M₁₁), where Mᵢ includes one or more symbols and is an ordered symbol segment within M, 1<=i<=n, where said partitioning is characterized by predetermined (sₙ, . . . , s₂, s₁), where sᵢ is the number of symbols in Mᵢ, 1<=i<=n,
said permutating is characterized by predetermined (pₙ, . . . , p₂, p₁), where pᵢ is the sequence position of Mᵢ in (M₁ₙ, . . . , M₁₂, M₁₁), 1<=i<=n,
wherein a secret key either explicitly or implicitly characterizes both said partitioning information (sₙ, . . . , s₂, s₁) and said permutating information (pₙ, . . . , p₂, p₁),
C. a decoding means for receiving C from said channel and for permutating C using said secret key to obtain message M.

2. A system according to claim 1 wherein at least one of said transforming means comprises:
a first memory buffer means for receiving and storing each symbol of a first digital signal representative of said signal-to-be-permutated in a predetermined order specified by said communications system, wherein the output of said first memory buffer means is in a predetermined order specified by said system, and
a first register means for receiving and storing a second digital signal representative of said secret key, and
a second memory buffer means for storing symbols of said ciphertext C in a predetermined order specified by said system upon transform completion, wherein output from said first memory buffer means is written into said second memory buffer means at the location determined by a symbol address signal, and
a second register means for receiving and storing said symbol address signal, and
a finite state machine means for generating said symbol address signal from said second digital signal and for writing said symbol address signal into said second register means.

3. A communications system for transferring message signals, comprising a plurality of terminals, wherein a first terminal includes means for encoding a message signal M for transmission from said first terminal to a second terminal, wherein M is an ordered sequence of symbols, wherein said first terminal includes means for transforming said message signal M for transmission to said second terminal, wherein
said transforming means includes steps of:
means for transforming said signal M into one or more message block signals M″, denoted as (mₖ, . . . , m₂, m₁), k<=kₘₐₓ, wherein kₘₐₓ is the maximum message symbol length specified by said system,
means for partitioning each of said message block signals M″ into (Mₙ, . . . , M₂, M₁), wherein Mᵢ includes one or more symbols and is an ordered symbol segment within M″, 1<=i<=n, wherein said
partitioning is characterized by predetermined (sₙ, s₂, s₁), where sᵢ is the number of symbols in M₁, 1<=i<=n, means for permutating (Mₙ, . . . , M₂, M₁) to (M₁ₙ, . . . , M₁₂, M₁₁), thereby obtaining a ciphertext C, wherein said permutating is characterized by predetermined (pₙ, . . . , p₁₂, p₁₁), where pᵢ is the sequence position of Mᵢ in (M₁ₙ, . . . , M₁₂, M₁₁), 1<=i<=n,
wherein a secret key either explicitly or implicitly characterizes both said partitioning information (sₙ, . . . , s₂, s₁) and said permutating information (pₙ, . . . , p₂, p₁).

4. A system according to claim 3 wherein at least one of said transforming means comprises:
a first memory buffer means for receiving and storing each symbol of a first digital signal representative of said signal-to-be-permutated in a predetermined order specified by said communications system, wherein the output of said first memory buffer means is in a predetermined order specified by said system, and
a first register means for receiving and storing a second digital signal representative of said secret key, and
a second memory buffer means for storing symbols of said ciphertext C in a predetermined order specified by said system upon transform completion, wherein output from said first memory buffer means is written into said second memory buffer means at the location determined by a symbol address signal, and
a second register means for receiving and storing said symbol address signal, and
a finite state machine means for generating said symbol address signal from said second digital signal and for writing said symbol address signal into said second register means.

5. The system of claim 3 further comprising:
means for transmitting said ciphertext signals C from said first terminal to said second terminal, wherein said second terminal includes means for receiving said ciphertext signals C from said channel and for decoding said ciphertext C to said message block signals M″ using said secret key and means for transforming said block signals M″ back to said message M.

6. A cryptographic communications system, comprising:
A. a communications channel;
B. an encoding means for transforming a message signal M to a ciphertext signal C for transmitting on said channel,
where said message M is an ordered sequence of symbols, denoted as (mₖ, . . . , m₂, m₁), k<=kₘₐₓ where kₘₐₓ is the maximum message symbol length specified by said system,
wherein said transforming comprises steps of:
1. means for partitioning said message M into (Mₙ, . . . , M₃, M₂, M₁), where Mᵢ includes one or more symbols and is an ordered symbol segment within M, 1<=i<=n, wherein said partitioning is characterized by predetermined (sₙ, . . . , s₂, s₁), where sᵢ is the number of symbols in Mᵢ, 1<=i<=n,
2. means for permutating (Mₙ, . . . , M₃, M₂, M₁) into (M₁ₙ, . . . , M₁₂, M₁₁), according to predetermined permutation information (pₙ, . . . , p₂, p₁), where pᵢ is the sequence position of Mᵢ in (M₁ₙ, . . . , M₁₂, M₁₁), 1<=i<=n,
3. means for repeating step 1 and step 2 on said symbol sequence M₁ᵢ recursively, in a predetermined manner not necessarily same as previous partition and permutation, until stopped by said system, 1<=i<=n,
wherein step 3 may not be necessarily required as specified by said system,
wherein a secret key characterizes all levels of partition information by (sₙ, . . . , s₂, s₁) and permutation information (pₙ, . . . , p₂, p₁),
C. a decoding means for receiving C from said channel and for transforming ciphertext C back to message M using said secret key.

7. A system according to claim 6 wherein at least one of said transforming means comprises:
a first memory buffer means for receiving and storing each symbol of a first digital signal representative of said signal-to-be-permutated in a predetermined order specified by said communications system, wherein the output of said first memory buffer means is in a predetermined order specified by said system, and
a first register means for receiving and storing a second digital signal representative of said secret key, and
a second memory buffer means for storing symbols of said ciphertext C in a predetermined order specified by said system upon transform completion, wherein output from said first memory buffer means is written into said second memory buffer means at the location determined by a symbol address signal, and
a second register means for receiving and storing said symbol address signal, and
a finite state machine means for generating said symbol address signal from said second digital signal and for writing said symbol address signal into said second register means.

8. A communications system for transferring message signals, comprising a plurality of terminals, wherein a first terminal includes means for encoding a message signal M for transmission from said first terminal to a second terminal, wherein M is an ordered sequence of symbols, wherein said first terminal includes means for transforming said message signal M to a ciphertext C for transmission to said second terminal, wherein
said transforming means includes steps of:
means for transforming said message M to one or more message block signals M″, denoted as (mₖ, . . . , m₂, m₁), where k<=kₘₐₓ, wherein kₘₐₓ is the maximum message symbol length specified by said system,
means for transforming message block signals M″, wherein said transforming comprises the sub-steps of:
1. means for partitioning said message block signal M″ into (Mₙ, . . . , M₂, M₁), where Mᵢ includes one or more symbols and is an ordered symbol segment within M″, where 1<=i<=n, wherein said partitioning is characterized by predetermined (sₙ, . . . , s₂, s₁), where sᵢ is the number of symbols in Mᵢ, where 1<=i<=n,
2. means for permutating (Mₙ, . . . , M₃, M₂, M₁) into (M₁ₙ, . . . , M₁₂, M₁₁), according to predetermined permutation information (pₙ, . . . , p₂, p₁), where pᵢ is the sequence position of Mᵢ in (M₁ₙ, . . . , M₁₂, M₁₁), 1<=i<=n,
3. means for repeating step 1 and step 2 on said symbol sequence M₁ᵢ recursively, in a predetermined manner not necessarily same as previous partition and permutation, until stopped by said system, where 1<=i<=n,
wherein said step 3 may not be necessarily required as specified by said system,
wherein a secret encryption key characterizes all levels of partition information (sₙ, . . . , s₂, s₁) and permutation information (pₙ, . . . , p₂, p₁).

9. A system according to claim 8 wherein at least one of said transforming means comprises:
a first memory buffer means for receiving and storing each symbol of a first digital signal representative of said signal-to-be-permutated in a predetermined order specified by said communications system, wherein the output of said first memory buffer means is in a predetermined order specified by said system, and
a first register means for receiving and storing a second digital signal representative of said secret key, and
a second memory buffer means for storing symbols of said ciphertext C in a predetermined order specified by said system upon transform completion, wherein output from said first memory buffer means is written into said second memory buffer means at the location determined by a symbol address signal, and
a second register means for receiving and storing said symbol address signal, and
a finite state machine means for generating said symbol address signal from said second digital signal and for writing said symbol address signal into said second register means.

10. The system of claim 8 further comprising:
means for transmitting said ciphertext signals C from said first terminal to said second terminal, wherein said second terminal includes means for receiving said ciphertext C from said channel and for decoding said ciphertext signals C to said message block signals M″ using said secret key and means for transforming said message block signals M″ back to said message M.

11. A secure distributed data storage system comprising a communications channel and a plurality of terminals, including a first terminal and a second terminal and n storage terminals, wherein
said first terminal comprises:
means for transforming said data M to a ciphertext C,
said transforming comprising the further steps of
1. means for partitioning said data M into (Mₙ, . . . , M₂, M₁), wherein said partitioning is characterized by predetermined (sₙ, . . . , s₂, s₁), where sᵢ is the number of symbols in Mᵢ, 1<=i<=n,
2. means for permutating (Mₙ, M₂, M₁) to (M₁ₙ, . . . , M₁₂, M₁₁), where said permutating is characterized by predetermined (pₙ, . . . , p₂, p₁), where pᵢ is the symbol sequence position of Mᵢ in (M₁ₙ, . . . , M₁₂, M₁₁), 1<=i<=n,
3. means for repeating step 1 and step 2 on said symbol sequence M₁ᵢ recursively, in a predetermined manner not necessarily same as previous partition and permutation, until stopped by said system, 1<=i<=n,
wherein, step 3 may not be neccesarily required as specified by said system,
wherein a secret key either explicitly or implicitly corresponds to all levels of said partitioning information (sₙ, . . . , s₂, s₁) and said permutating information (pₙ, . . . , p₂, p₁).
means for transferring said permutated symbol sequences M₁ₙ, . . . , M₁₂ and M₁₁ to said n storage terminals respectively over said channel.
each of said n storage terminals includes means for receiving one of said n permutated symbol sequences and storing received symbol sequence on said storage terminal.
said second terminal includes means for receiving said n permutated symbol sequences from said n storage terminals and for decoding said n permutated symbol sequences to said data block M using said secret key.

12. A system according to claim 11 wherein at least one of said transforming means comprises:
a first memory buffer means for receiving and storing each symbol of a first digital signal representative of said signal-to-be-permutated in a predetermined order specified by said communications system, wherein the output of said first memory buffer means is in a predetermined order specified by said system, and
a first register means for receiving and storing a second digital signal representative of said secret key, and
a second memory buffer means for storing symbols of said ciphertext C in a predetermined order specified by said system upon transform completion, wherein output from said first memory buffer means is written into said second memory buffer means at the location determined by a symbol address signal, and
a second register means for receiving and storing said symbol address signal, and
a finite state machine means for generating said symbol address signal from said second digital signal and for writing said symbol address signal into said second register means.

13. A secure distributed data storage system comprising a communications channel and a plurality of terminals, wherein a first terminal includes:
means for encoding a data M for transmission from said first terminal to n storage terminals, wherein M is an ordered sequence of symbols, wherein said first terminal includes
means for transforming said data M for transmission to n storage terminals, wherein said transforming means includes steps of:
means for transforming said data M into one or more data block signals M″, denoted as (mₖ, . . . , m₂, m₁), k<=kₘₐₓ, wherein kₘₐₓ is the maximum data symbol length specified by said system,
means for transforming each of said data block M″ to a ciphertext C, said transforming comprising the further steps of
1. means for partitioning each of said data block M″ into (Mₙ, . . . , M₂, M₁), wherein said partitioning is characterized by predetermined (sₙ, . . . , s₂, s₁), where sᵢ is the number of symbols in Mᵢ, 1<=i<=n,
2. means for permutating (Mₙ, . . . , M₂, M₁) to (M₁ₙ, . . . , M₁₂, M₁₁), where said permutating is characterized by predetermined (pₙ, . . . , p₂, p₁), where pᵢ is the symbol sequence position of Mᵢ in (M₁ₙ, . . . , M₁₂, M₁₁), 1<=i<=n,
3. means for repeating step 1 and step 2 on said symbol sequence M₁ᵢ recursively, in a predetermined manner not necessarily same as previous partition and permutation, until stopped by said system, 1<=i<=n,
wherein, step 3 may not be neccesarily required as specified by said system,
wherein a secret key either explicitly or implicitly corresponds to all levels of said partitioning information (sₙ, . . . , s₂, s₁) and said permutating information (pₙ, . . . , p₂, p₁).
means for transferring said n permutated symbol sequences M₁ₙ, . . . , M₁₂, M₁₁ to said n storage terminals respectively over said channel.

14. A system according to claim 13 wherein at least one of said transforming means comprises:
a first memory buffer means for receiving and storing each symbol of a first digital signal representative of said signal-to-be-permutated in a predetermined order specified by said communications system, wherein the output of said first memory buffer means is in a predetermined order specified by said system, and
a first register means for receiving and storing a second digital signal representative of said secret key, and
a second memory buffer means for storing symbols of said ciphertext C in a predetermined order specified by said system upon transform completion, wherein output from said first memory buffer means is written into said second memory buffer means at the location determined by a symbol address signal, and
a second register means for receiving and storing said symbol address signal, and
a finite state machine means for generating said symbol address signal from said second digital signal and for writing said symbol address signal into said second register means.

15. The system of claim 13 further comprising:
said n storage terminals wherein each of said n storage terminals includes means for receiving one of said n permutated symbol sequences from said channel and storing received symbol sequence on said storage terminal.
a second terminal including means for receiving said n permutated symbol sequences from said n storage terminals over said channel and for decoding said n permutated symbol sequences to said data block signals M″ using said secret key and means for transforming said data block signals M″ back to said data M.

16. A method for transferring a message M in a communications system having a plurality of terminals, comprising the steps of:
encoding a message signal M for transmission from a first terminal to a second terminal, wherein M is an ordered sequence of symbols, said encoding step including the sub-steps of
transforming said message signal M to one or more message block signals M″, each of block signals M″ being representative of a portion of said message M, denoted as (mₖ, . . . , m₂, m₁), k<=kₘₐₓ, where kₘₐₓ is the maximum message symbol length specified by said system,
transforming each of said block signals to a ciphertext signal C, said transforming comprising:
partitioning each of said message block signals M″ into (Mₙ, . . . , M₂, M₁), wherein said partitioning is characterized by predetermined (sₙ, . . . , s₂, s₁, where sᵢ is the number of symbols in Mᵢ, 1<=i<=n,
permutating (Mₙ, . . . , M₂, M₁) to (M₁ₙ, . . . , M₁₂, M₁₁), where said permutating is characterized by predetermined (pₙ, . . . , p₂, p₁), where pᵢ is the symbol sequence position of Mᵢ in (M₁ₙ, . . . , M₁₂, M₁₁), 1<=i<=n,
wherein a secret key either explicitly or implicitly corresponds to both said partitioning information (sₙ, . . . , s₂, s₁) and said permutating information (pₙ, . . . , p₂, p₁).

17. The method of claim 16 comprising the further steps of:
transmitting said ciphertext signals C to said second terminal, and decoding said ciphertext signals C to said message M, said decoding step including:
transforming said ciphertext signals C to said block signals M″ using said secret key,
transforming block signals M″ back to said message signal M.

18. A method for transferring a message M in a communications system having a plurality of terminals, comprising the steps of:
encoding a message signal M for transmission from a first terminal to a second terminal, wherein M is an ordered sequence of symbols, said encoding step including the sub-steps of
transforming said message signal M to one or more message block signals M″, each of block signals M″ being representative of a portion of said message M, denoted as (mₖ, . . . , m₂, m₁), k<=kₘₐₓ, where kₘₐₓ is the maximum message symbol length specified by said system,
transforming each of said block signals M″ to a ciphertext signal C, said transforming comprising the further steps of
1. partitioning each of said message block signals M″ into (Mₙ, . . . , M₃, M₂, M₁), where Mᵢ includes one or more symbols and is an ordered symbol segment within M, 1<=i<=n, wherein said partitioning is characterized by predetermined (sₙ, . . . , s₂, s₁), where sᵢ is the number of symbols in Mᵢ, 1<=i<=n,
2. permutating (Mₙ, . . . , M₃, M₂, M₁) into (M₁ₙ, . . . , M₁₂, M₁₁), according to predetermined permutation information (pₙ, . . . , p₂, p₁), where pᵢ is the sequence position of Mᵢ in (M₁ₙ, . . . , M₁₂, M₁₁), 1<=i<=n,
3. repeating step 1 and step 2 on said symbol sequence M₁ᵢ recursively, in a predetermined manner not necessarily same as previous partition and permutation, until stopped by said system, 1<=i<=n,
wherein said step 3 may not be necessarily required as specified by said system,
wherein a secret encryption key characterizes all levels of partition and permutation performed on said block signals M″ to obtain said ciphertext signals C.

19. The method of claim 18 comprising the further steps of:
transmitting said ciphertext signals C to said second terminal, and
decoding said ciphertext signals C to said message M, said decoding step including:
transforming said ciphertext signals C to said block signals M″ using said secret encryption key,
transforming block signals M″ back to said message signal M.

20. A method for storing a data M in a distributed storage system having a plurality of terminals, comprising the steps of:
encoding a data M for transmission from a first terminal to n storage terminals, wherein M is an ordered sequence of symbols, said encoding step including the sub-steps of
transforming said data M to one or more data blocks M″, each of data blocks M″ being a portion of said data M and denoted as (mₖ, . . . , m₂, m₁), k<=kₘₐₓ, where kₘₐₓ is the maximum data symbol length specified by said system,
transforming each of said data blocks M″ to a ciphertext C, said transforming comprising the further steps of
1. partitioning each of said data blocks M″ into (Mₙ, . . . , M₂, M₁), wherein said partitioning is characterized by predetermined (sₙ, . . . , s₂, s₁), where si is the number of symbols in Mᵢ, 1<=i<=n,
2. permutating (Mₙ, . . . , M₂, M₁) to (M₁ₙ, . . . , M₁₂, M₁₁), where said permutating is characterized by predetermined (pₙ, . . . , p₂, p₁), where pᵢ is the symbol sequence position of Mᵢ in (M₁ₙ, . . . , M₁₂, M₁₁), 1<=i<=n,
3. repeating step 1 and step 2 on said symbol sequence M₁ recursively, in a predetermined manner not necessarily same as previous partition and permutation, until stopped by said system, 1<=i <=n,
wherein, step 3 may not be neccesarily required as specified by said system,
wherein a secret key either explicitly or implicitly corresponds to all levels of said partitioning information (sₙ, . . . , s₂, s₁) and said permutating information (pₙ, . . . , p₂, p₁).
transmitting said permutated symbol sequences M₁ₙ, . . . , M₁₂ and M₁₁ to said n storage terminals respectively, and storing on said n storage terminals respectively.

21. The method of claim 20 comprising the further steps of:
transmitting said n symbol sequences M₁ₙ, . . . , M₁₂ and M₁₁ from said n storage terminals respectively to a second terminal,
decoding said n symbol sequences M₁ₙ, . . . , M₁₂ and M₁₁ to said data M, said decoding step includes:
transforming said n permutated symbol sequences M₁ₙ, . . . , M₁₂ and M₁₁ to said block data M″ using said secret key,
transforming said block data M″ back to said data M.
